(19) United States
(12) Patent Application Publication
(10) Pub. No.: US 2010/0279075 A1
(43) Pub. Date: Nov. 4, 2010

(54) METHOD FOR MANUFACTURING PATTERNED MICROSTRUCTURE AND CASE

(76) Inventor: Chien-Hsu Hou, TAIPEI CITY (TW)

Correspondence Address: NORTH AMERICA INTELLECTUAL PROPERTY CORPORATION, P.O. BOX 506, MERRIFIELD, VA, 22116, US

(21) Appl. No.: 12/769,663

(22) Filed: Apr. 29, 2010

(30) Foreign Application Priority Data
Apr. 29, 2009 (TW) 098114253

(51) Int. Cl. B32B 3/00; B32B 38/10

(52) U.S. Cl. 428/172; 156/247

(57) ABSTRACT

A method for manufacturing a patterned microstructure and a case with the patterned microstructure are provided. The method for manufacturing the patterned microstructure includes the following steps. A release layer is coated on a film with a micro pattern layer. A UV resin layer is coated on the release layer. The UV resin layer is hardened to form the patterned microstructure. The micro pattern layer and the film are removed by the release layer.

### CROSS-REFERENCE TO RELATED APPLICATIONS

This Non-provisional application claims priority under 35 U.S.C. §119(a) on Patent Application No(s). 098114253 filed in Taiwan, Republic of China on Apr. 29, 2009, the entire contents of which are hereby incorporated by reference.

### BACKGROUND OF THE INVENTION

1. Field of the Invention

This invention relates to a method for manufacturing a microstructure and a case and, more particularly, to a method for manufacturing a patterned microstructure and a case.

2. Description of the Related Art

Conventionally, a shell of an electronic device is mostly made of plastic or metal. The shell made of metal is taken for example. Generally, if pattern are made on the metal shell, the shell needs to be particularly processed. For example, after the metal shell is processed by a polishing machine, a carving machine, a computer number control (CNC) processing machine, a miller, and other machines, to make the patterned metal shell of the electronic device. Thus, the processes are often complex and the manufacturing time of the processes is longer. At the same time, the cost is high, and the manufactured pattern changes fail to generate luster effects. Therefore, aesthetic of the electronic device fails to be enhanced.

Therefore, to generate the pattern with luster effects on the shell of the electronic device, micro pattern products are developed. Most micro pattern products are made of plastic and manufactured by an in-mold forming (IMF) process. There is an embrittlement problem of plastic in the in-mold forming process. Particularly, the in-mold forming process easily fails at a turning place of patterns.

### BRIEF SUMMARY OF THE INVENTION

This invention provides a method for manufacturing a patterned microstructure and a case with the patterned microstructure. According to the method in the invention, without complex manufacturing processes, the patterned microstructure with luster can be formed on a case of an electronic device further to enhance aesthetic of the case of the whole electronic device.

The invention provides a method for manufacturing a patterned microstructure for a case body. The method includes the following steps. A release layer is coated on a film with a micro pattern layer. A UV resin layer is coated on the release layer. The UV resin layer is hardened to form the patterned microstructure. The micro pattern layer and the film separated from the UV resin layer by the release layer.

The invention also provides a case including a case body, an adhering layer, and a patterned microstructure. The adhering layer is adhered to the case body. The patterned microstructure is disposed on the adhering layer. The method for manufacturing the patterned microstructure includes the following steps. A release layer is coated on a film with a micro pattern layer. A UV resin layer is coated on the release layer. The UV resin layer is hardened to form the patterned microstructure. The micro pattern layer and the film are separated from the UV resin layer by the release layer.

These and other features, aspects, and advantages of the present invention will become better understood with regard to the following description, appended claims, and accompanying drawings.

### BRIEF DESCRIPTION OF THE DRAWINGS

FIG. 1A is a first schematic diagram showing an patterned microstructure according to a first embodiment of the invention;

FIG. 1B is a second schematic diagram showing the patterned microstructure according to the first embodiment of the invention;

FIG. 1C is a third schematic diagram showing the patterned microstructure according to the first embodiment of the invention;

FIG. 1D is a fourth schematic diagram showing the patterned microstructure according to the first embodiment of the invention;

FIG. 1E is a fifth schematic diagram showing the patterned microstructure according to the first embodiment of the invention;

FIG. 2A is a first schematic diagram showing an patterned microstructure according to a second embodiment of the invention; and

FIG. 2B is a second schematic diagram showing the patterned microstructure according to the second embodiment of the invention.

### DETAILED DESCRIPTION OF THE INVENTION

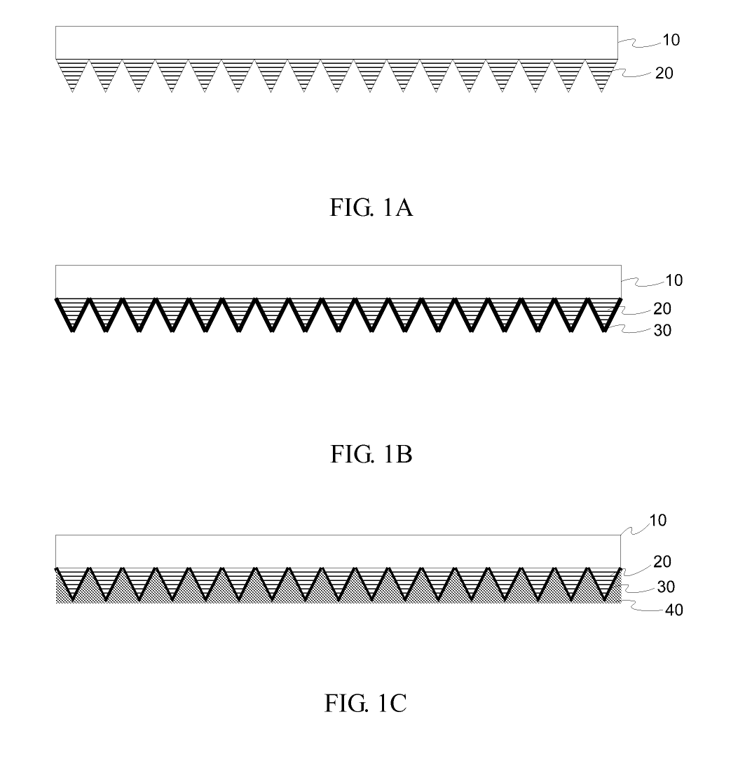

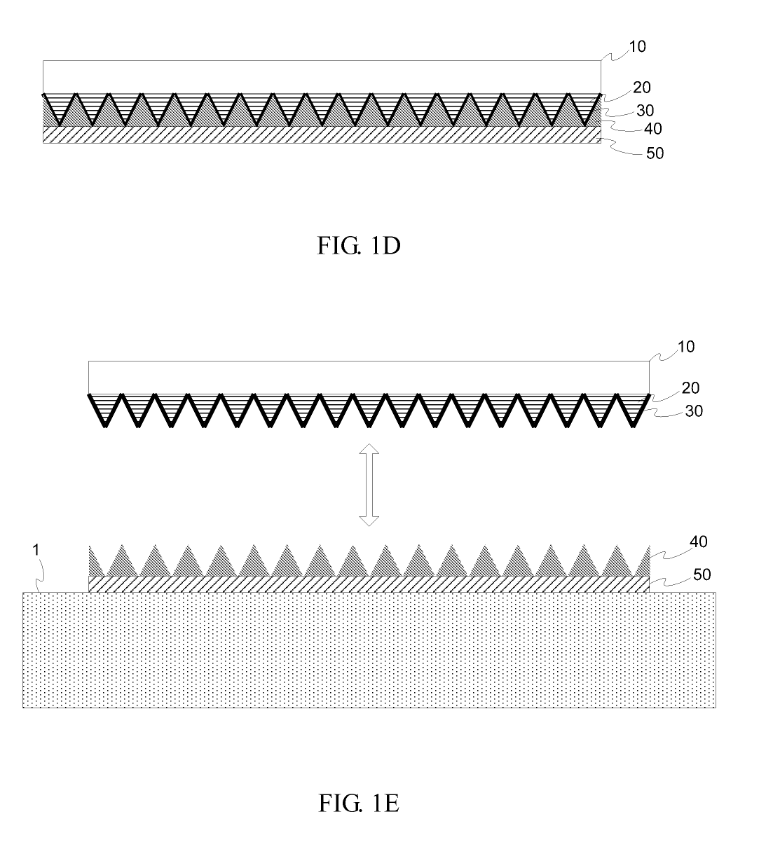

FIG. 1A to FIG. 1E are first to fifth schematic diagrams showing a patterned microstructure according to a first embodiment of the invention. The patterned microstructure in the first embodiment of the invention is for a case of an electronic device for decorating a case body 1 to allow the case to have the patterned microstructure with variety and luster effects.

Refer to FIG. 1A, a film 10 with a micro pattern layer 20 is provided. In the embodiment, the film 10 may be made of PET, PVC, or PP and so on, and the thickness is about 23˜125 μm. The micro pattern layer 20 is disposed on the film 10. The thickness of the micro pattern layer 20 is about 5˜20 μm, and it can be made of UV resin. To cooperate with the manufacture, the micro pattern layer 20 may be made of a harder material, and the material may have some differences from that of a UV resin layer 40 described hereinbelow.

In FIG. 1B, a release layer 30 is coated on the micro pattern layer 20 according to the shape of the micro pattern layer 20. Thus, the film 10 and the micro pattern layer 20 may be easily removed in the subsequence step, which is described in detail hereinbelow. The thickness of the release layer 30 is about 3 μm.

In FIG. 1C, a UV resin layer 40 is coated on the release layer 30. At that moment, the coated UV resin layer 40 is not solidified and soft. Therefore, the UV resin layer 40 is shaped according to the shape of the micro pattern layer 20. That is, the micro pattern layer 20 is similar to a mold for shaping the UV resin layer 40. The micro pattern layer 20 may have different shape or pattern, thereby forming the UV resin layer 40 with different shapes or patterns. After the UV resin layer 40 is coated, the soft UV resin layer 40 is cured with UV light to be hardened and to form the patterned microstructure.

In FIG. 1D, an adhering layer 50 is disposed on the patterned microstructure formed by the UV resin layer 40 for subsequence adhering. In FIG. 1E, the adhering layer 50 is adhered to the case body 1. The adhering layer 50 may be a hot melt adhesive. Therefore, the adhering layer 50 may be melted by heating the adhering layer 50, thereby successfully adhering the adhering layer 50 to the case body 1. Then, the micro pattern layer 20 and the film 10 are separated from the UV resin layer 40 by the coated release layer 30. That is, the micro pattern layer 20 and the film 10 are removed.

Thus, after the adhering layer 50 is adhered, the UV resin layer 40 with patterns becomes the exterior layer of the case body 1. In addition, since the UV resin layer 40 has various characteristics such as better hardness, wear-resistant, solvent resistance and so on, the UV resin layer 40 satisfies the requires of the exterior layer of the case body 1. In addition, the case body 1 may be made of metal or plastic. However, the invention is not limited thereto.

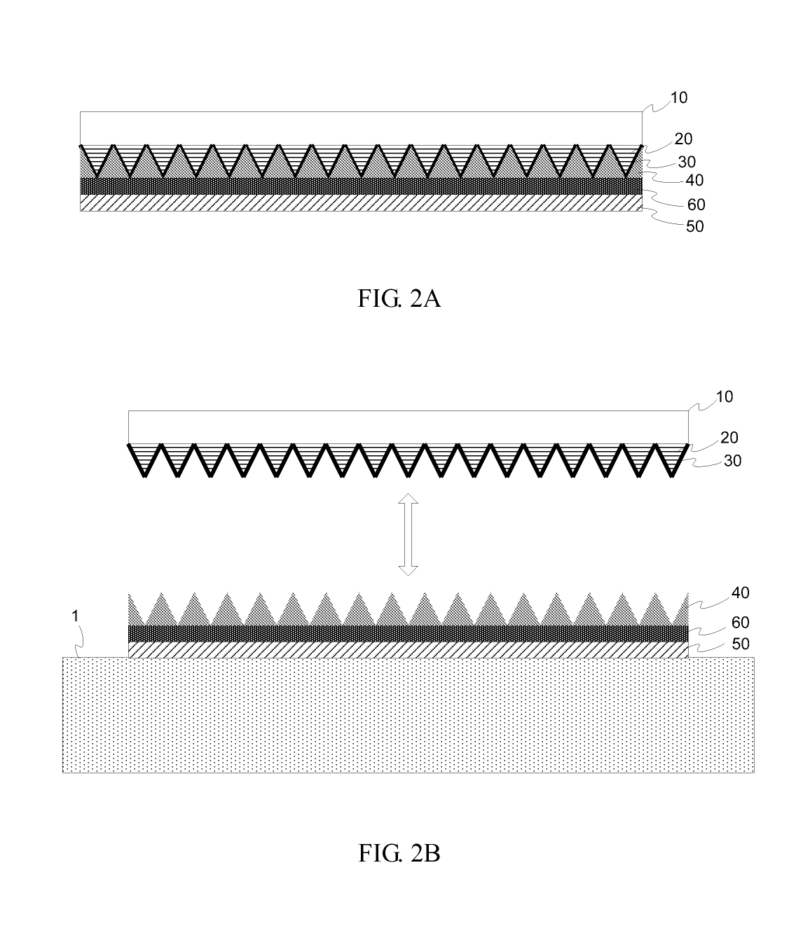

FIG. 2A and FIG. 2B are first and second schematic diagrams showing a patterned microstructure according to a second embodiment of the invention. The difference between the first embodiment and the second embodiment is that the second embodiment includes a decoration layer 60.

After a UV resin layer 40 is coated on a release layer 30 and the UV resin layer 40 is hardened to form the patterned microstructure, the decoration layer 60 may be first disposed on the patterned microstructure formed by the UV resin layer 40. The patterned microstructure formed by the UV resin layer 40 may be transparent, and the decoration layer 60 may be disposed on the UV resin layer 40 to increase variety. The decoration layer 60 may be a color printing layer or an aluminum evaporation layer formed in a printing mode or an evaporation mode, respectively. When the decoration layer 60 is the color printing layer, the color printing layer may be used to change the color presented by the patterned microstructure. In another aspect, when the decoration layer 60 is the aluminum evaporation layer, the patterned microstructure may present metallic appearance.

In the second embodiment, an adhering layer 50 is disposed on the decoration layer 60. That is, the decoration layer 60 is disposed between the adhering layer 50 and the patterned microstructure formed with the UV resin layer 40 as shown in FIG. 2A. In the embodiment, the decoration layer 60 and the patterned microstructure formed with the UV resin layer 40 are adhered to a case body 1 by the adhering layer 50, and an micro pattern layer 20 and a film 10 are removed by a release layer 30 as shown in FIG. 2B.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A method for manufacturing a patterned microstructure for a case body, the method comprising the following steps of:
coating a release layer on a film with an micro pattern layer;
coating a UV resin layer on the release layer;
hardening the UV resin layer to form an patterned microstructure; and
separating the micro pattern layer and the film by the release layer.

2. The method for manufacturing a patterned microstructure according to claim 1, wherein the film is selected from the group consisting of PET, PVC, PP, and a combination thereof.

3. The method for manufacturing a patterned microstructure according to claim 1, wherein the thickness range of the film is essentially 23˜125 μm.

4. The method for manufacturing a patterned microstructure according to claim 1, wherein the thickness range of the micro pattern layer is essentially 5˜20 μm.

5. The method for manufacturing a patterned microstructure according to claim 1, wherein the thickness range of the release layer is essentially 3 μm.

6. The method for manufacturing a patterned microstructure according to claim 1, wherein the patterned microstructure is transparent.

7. The method for manufacturing a patterned microstructure according to claim 1, further comprising the following steps of:
disposing an adhering layer at the patterned microstructure; and
adhering the adhering layer to the case body.

8. The method for manufacturing a patterned microstructure according to claim 7, wherein the step of adhering the adhering layer to the case body comprises the following step of:
heating the adhering layer to melt the adhering layer.

9. The method for manufacturing a patterned microstructure according to claim 1, further comprising the following steps of:
disposing a decoration layer at the patterned microstructure;
disposing an adhering layer at the decoration layer; and
adhering the adhering layer to the case body.

10. The method for manufacturing a patterned microstructure according to claim 9, wherein the step of adhering the adhering layer to the case body comprises the following step of:
heating the adhering layer to melt the adhering layer.

11. The method for manufacturing a patterned microstructure according to claim 9, wherein the step of disposing the decoration layer at the patterned microstructure comprises the following step of:
printing a color printing layer to form the decoration layer.

12. The method for manufacturing a patterned microstructure according to claim 9, wherein the step of disposing the decoration layer at the patterned microstructure comprises the following step of:
evaporating an aluminum evaporation layer to form the decoration layer.

13. A case comprising:
a case body;
an adhering layer adhered to the case body; and
a patterned microstructure disposed on the adhering layer, the method for manufacturing the patterned microstructure including the following steps of:
coating a release layer on a film with an micro pattern layer;
coating a UV resin layer on the release layer;
hardening the UV resin layer to form the patterned microstructure; and
separating the micro pattern layer and the film by the release layer.

14. The case according to claim 13, wherein the patterned microstructure is transparent.

15. The case according to claim 13, further comprising a decoration layer disposed between the adhering layer and the patterned microstructure.

16. The case according to claim 15, wherein the decoration layer includes a color printing layer or an aluminum evaporation layer.

17. The case according to claim 13, wherein the case body is made of metal or plastic.
